(19) United States
(12) Patent Application Publication
(10) Pub. No.: US 2010/0316560 A1
(43) Pub. Date: Dec. 16, 2010

(54) PROCESS FOR THE PRODUCTION OF MIXED-METAL-OXIDE INORGANIC PIGMENTS FROM INDUSTRIAL WASTES

(76) Inventors: João António Labrincha Batista, Aveiro (PT); Manuel Joaquim Peixoto Marques Ribeiro, Eixo (PT); Marla Grácia Cordeiro da costa, Viana Do Castelo (PT)

Correspondence Address: KENEALY VAIDYA LLP, 515 EAST BRADDOCK RD SUITE B, Alexandria, VA, 22314, US

(21) Appl. No.: 12/521,439

(22) PCT Filed: Dec. 27, 2007
(86) PCT No.: PCT/IB2007/055320

§ 371 Date: Jun. 26, 2009

(30) Foreign Application Priority Data
Dec. 27, 2006 (PT) 103624

(51) Int. Cl. C01B 13/14

(52) U.S. Cl. 423/593.1

(57) ABSTRACT

The invention relates to the production of mixed-metal-oxide inorganic pigments, using industrial waste as raw materials, comprising the following steps: (i) characterization and selection of wastes; (ii) their treatment, if required; (iii) formulation+dosing+mixing of components; (iv) drying+calcination; and (v) washing+milling. Selected wastes might be used in the as-received condition or after drying or calcination. The present invention deals with materials that are produced by colorants or pigments producers mainly for use in the ceramic sector, since formulations are stable at high temperatures and act as colorants of glazes or ceramic bodies. The use of high temperatures might also assure the desirable inertization of possible hazardous species.

### TECHNICAL FIELD OF THE INVENTION

The present invention refers to a method of inorganic pigments from several industrial wastes. The correct definition of treatment and processing conditions, leads to the formation of colouring materials or pigments, having high thermal and chemical stability and then suitable to be used by distinct industrial products, such as ceramic, glass and plastic.

### BACKGROUND OF THE INVENTION

The coloured pigments to be used in products that are processed at high temperature might be divided in three groups: (i) metallic colloids (e.g. copper); (ii) oxides; and (iii) non-oxides (e.g. cadmium sulphide or selenium).

The group of oxides might further be divided in two sub-groups: (i) simple oxides (e.g. NiO); and (ii) mixed oxides (e.g. spinels).

According to the structure, an inorganic pigment is composed of a crystalline network that hosts the colouring element or chromophore (normally a transition metal cation) and possible modifying components, used to intensify or modify the colour/hue. Frequently, pigments formulations contain fluxing/mineralising additives that improve the reactivity between the components, and consequently contribute to lower the calcination temperature and/or time to produce the pigment.

The production of inorganic pigments normally involves the use of pure oxides or salts (carbonates, chlorides, sulphates and nitrates) of the required metals, that convert to the corresponding oxides during the calcination process.

Concerning the location of the chromophore in the lattice, pigments might be divided into four classes:
structural pigments, if the chromophore is an intrinsic element of the structure;
solid solution pigments, if the chromophore substitutes one or more native ion in the host lattice;
encapsulation or occlusion pigments, where the chromophore element or the corresponding crystals are encapsulated by a crystal of the hosting material;
mordant pigments, if the chromophore element is just superficially incorporated in the host lattice.

In the actual invention, we produce both structural and solid solution metallic oxide inorganic pigments.

The sub-group of mixed-metal-oxide inorganic pigments was classified by the DCMA, Dry Colors Manufacturers Association (EUA), based on their crystalline structure. Table 1 lists all types of such pigments.

TABLE 1
Classification of Mixed-Metal-Oxide Inorganic Pigments made
by the DMCA (Dry Colors Manufacturers Association - EUA)

| DCMA number | Crystal class and name (categories) |
|---|---|
| | I. Baddeleyte |
| 1-01-4 | Zirconium vanadium yellow baddeleyte, |
| | (Zr,V)O₂ |
| | II. Borate |
| 2-02-1 | Cobalt magnesium purple borate, |
| | (Co,Mg)₂B₂O₅ |
| | III. Corundum-Hematite |
| 3-03-5 | Chrome alumina pink corundum, |
| | (Al,Cr)₂O₃ |
| 3-04-5 | Manganese alumina pink corundum, |
| | (Al,Mn)₂O₃ |
| 3-05-3 | Chromium dark green hematite |
| 3-06-7 | Iron brown hematite |
| | IV. Garnet |
| 4-07-3 | Victoria green garnet, Ca₃Cr₂(SiO₄)₃ |
| | V. Olivine |
| 5-08-2 | Cobalt silicate blue olivine, Co₂SiO₄ |
| 5-45-3 | Nickel silicate green olivine, Ni₂SiO₄ |
| | VI. Periclase |
| 6-09-8 | Cobalt nickel grey periclase, (Co,Ni)O |
| | VII. Phenacite |
| 7-10-2 | Cobalt zinc silicate blue phenacite, |
| | (Co,Zn)₂SiO₂ |
| | VIII. Phosphate |
| 8-11-1 | Cobalt violet phosphate, Co₃(PO₄)₂ |
| 8-12-1 | Cobalt lithium violet phosphate, LiCoPO₄ |
| | IX. Priderite |
| 9-13-4 | Nickel barium titanium primerose |
| | priderite, Ba₃Ni₂Ti₁₇O₃₉ |
| | X. Pyrochlore |
| 10-14-4 | Lead antimonite yellow pyrochlore, Pb₂Sb₂O₇ |
| | XI. Rutile-Cassiterite |
| 11-15-4 | Nickel antimony titanium yellow rutile, |
| | (Ni,Ti,Sb)O₂ |
| 11-16-4 | Nickel niobium titanium yellow rutile, |
| | (Ni,Ti,Nb)O₂ |
| 11-17-6 | Chrome antimony titanium buff rutile, |
| | (Ti,Cr,Sb)O₂ |
| 11-18-6 | Chrome niobium titanium buff rutile, |
| | (Ti,Cr,Nb)O₂ |
| 11-19-6 | Chrome tungsten titanium buff rutile, |
| | (Ti,Cr,W)O₂ |
| 11-20-6 | Manganese antimony titanium buff rutile, |
| | (Ti,Mn,Sb)O₂ |
| 11-21-8 | Titanium vanadium antimony gray rutile, |
| | (Ti,V,Sb)O₂ |
| 11-22-4 | Tin vanadium yellow cassiterite, (Sn,V)O₂ |
| 11-23-4 | Chrome tin orchid purple cassiterite, |
| | (Sn,Cr)O₂ |
| 11-24-8 | Tin antimony gray cassiterite, (Sn,Sb)O₂ |
| 11-46-7 | Manganese chrome antimony titanium |
| | brown rutile, (Ti,Sb,Cr,Mn)O₂ |
| 11-47-7 | Manganese niobium titanium brown rutile, |
| | (Ti,Nb,Mn)O₂ |
| | XII. Sphene |
| 12-25-5 | Chrome tin carmine sphene, |
| | CaSnSiO₅: Cr₂O₃ |
| | XIII. Spinel |
| 13-26-2 | Cobalt aluminate blue spinel, CoAl₂O₄ |
| 13-27-2 | Cobalt tin blue-gray spinel, Co₂SnO₄ |
| 13-28-2 | Cobalt zinc aluminate blue spinel, |
| | (Co,Sn)Al₂O₄ |
| 13-29-2 | Cobalt chromite blue-green spinel, |
| | Co(Al,Cr)₂O₄ |
| 13-30-3 | Cobalt chromite green spinel, CoCr₂O₄ |
| 13-31-3 | Cobalt titanate green spinel, Co₂TiO₄ |
| 13-32-5 | Chrome alumina pink spinel, Zn(Al,Cr)₂O₄ |
| 13-33-7 | Iron chromite brown spinel, Fe(Fe,Cr)₂O₄ |
| 13-34-7 | Iron titanium brown spinel, Fe₂TiO₄ |
| 13-35-7 | Nickel ferrite brown spinel, Fe(Fe,Cr)₂O₄ |
| 13-36-7 | Zinc iron chromite brown spinel, |
| | (Zn,Fe)Fe₂O₄ |
| 13-37-7 | Zinc ferrite brown spinel, |
| | (Zn,Fe)(Fe,Cr)₂O₄ |
| 13-38-9 | Copper chromite black spinel, CuCr₂O₄ |
| 13-39-9 | Iron cobalt black spinel, (Fe,Co)Fe₂O₄ |
| 13-40-9 | Iron cobalt chromite black spinel, |
| | (Fe,Co)(Fe,Cr)₂O₄ |
| 13-41-9 | Manganese ferrite black spinel, |
| | (Fe,Mn)(Fe,Mn)₂°₄ |
| 13-48-7 | Chrome iron manganese brown spinel, |
| | (Fe,Mn)(Fe,Mn,Cr)₂O₄ |
| 13-49-2 | Cobalt tin alumina blue spinel, |
| | (Sn,Co)(Al,Co)₂°₄ |
| 13-50-9 | Chrome iron nickel black spinel, |
| | (Ni,Fe)(Fe,Cr)₂O₄ |
| 13-51-7 | Chrome manganese zinc brown spinel, |
| | (Zn,Mn)(Mn,Cr)₂O₄ |
| | XIV. Zircon |
| 14-42-2 | Zirconium vanadium blue zircon, |
| | (Zr,V)SiO₄ |
| 14-43-4 | Zirconium praseodymium yellow zircon, |
| | (Zr,Pr)SiO₄ |
| 14-44-5 | Zirconium iron pink zircon, (Zr,Fe)SiO₄ |

Industrial wastes or by-products are normally disposed in proper land fields, with increasing costs for the producer. Moreover, recent EU directives tend to limit or reduce such action, stimulating the search for viable recycling alternatives. In some cases, residues are incinerated in cement kilns. Recycling of such materials attempt to use them as secondary raw materials for distinct alternative products.

Production costs of common pigments have been increasing in recent years, namely because some natural raw materials (e.g. Zn, Ni, Co) became scarce and costly. One of the current trends is the search for alternative and less expensive raw materials. Normally, these raw materials have high-grade chemical purity, but less pure raw materials are often tried since prove to have enough stability and are less expensive. Selected industrial wastes have been investigated for this purpose, and in particular, metal-rich sludges seem to be very promising.

In particular, metal-rich sludges might act as colouring agents, or might be combined with other materials acting in this case as the host for diverse colouring species. A wide range of metals might be interesting, as shown in table 1, if their source transforms in to oxides upon suitable calcination in oxidising atmosphere. As obvious, waste streams should show reasonably chemical constancy or properly pre-treated to assure that criterion.

PT 103269 describes the synthesis of inorganic pigments by solid state reaction, from industrial wastes, in particular sludges generated in the wastewater treatment of galvanizing or surface coating processes, pickling material used in the shipbuilding industry, foundry sands, and fines or sludge from the cutting and polishing of natural stones.

The actual invention describes the synthesis of pigments to be mainly used in ceramics, involving primarily a judicious characterization, selection, and treatment of wastes, attempting to assure their adaptability to form highly stable pigments formulations.

The step of characterization and selection of wastes determines which ones are suitable for this purpose, based on the high concentration of metallic elements that transform, upon calcination in oxidizing atmosphere, into the corresponding oxides. Moreover, when hazardous species are detected in relatively high concentrations, a proper treatment is applied to assure that the manipulation of such material is absolutely safety. This treatment is also important to improve the homogeneity of the material, increasing then the chemical stability of the resulting pigments. This point contradicts what is postulated in the above mentioned PT103269 document, since these preliminary steps of characterization, selection and treatment of wastes are omitted there.

The actual invention describes the synthesis of structural and solid solution pigments. In the last type, the chromophore ions will partially substitute a forming native ion in the lattice, and their admissible concentration is controlled by the solubility limit in the structure. In this way, the hue stability of the pigment is assured. In opposition, in a structural pigment the chromophore specie belongs to native lattice and a judicious balance of all structural components should be assured in the mixture to obtain the desirable stoichiometry. In the present invention, the wastes might introduce any element, independently of its faction in the structure/lattice (chromophore, forming, modifying or mineraliser).

The actual process, involving a correct formulation of well characterized and selected/processed wastes, assures the complete inertization of possible hazardous species in the formed high stable structure, resulting in a product that is absolutely non-hazardous.

### General Description of the Invention

The present invention describes the synthesis of coloured mixed-metal-oxide inorganic pigments from several industrial wastes that were primarily selected and treated.

The pigments produced according to the actual process are inorganic compounds that can then be added to vitreous or ceramic matrixes, give them an uniform colour without altering their common physical properties. To be used, those pigments should obey to the following requirements:
thermostability: the crystalline structure should remain stable and unchanged at high temperatures;
insolubility in the glassy or solid matrix: when added to a glaze or ceramic body, the pigment structure should remain insoluble and unreactive upon firing in order to give a homogeneous colouration to the material;
inert in affecting the physical properties of the matrix: the pigment should not alter the intrinsic characteristics of the material in which it was inserted, namely its wear and abrasion resistance, tendency to crack, durability, etc.

The actual invention assumes the use of industrial wastes as raw materials for pigments formulations listed in the DCMA, Dry Colors Manufactures Association, classification (Table 1), after a correct treatment to assure the desirable constancy in the chemical composition.

According the actual invention several wastes might be used, in particular sludges generated in the wastewater treatment of galvanizing or surface coating processes, pickling material used in the shipbuilding industry, foundry sands, and fines or sludge from the cutting and polishing of natural stones.

The waste might substitute one or several primary raw materials normally used to obtain the pigment.

The wastes might be used in the as-received condition or after suffering distinct pretreatments: drying, calcination, milling, etc.

According to the actual invention, the process for the synthesis of the inorganic pigments, consists on the judicious choice and use of metal-rich industrial wastes, alone or combined with distinct components (wastes or primary raw materials). Normally, oxides or salts of the corresponding oxides are used to formulate the pigment. The correct dosage, homogeneous mixing of components, calcination, and washing+milling, are the basic steps to get chemically and thermally stable inorganic pigments.

Thus, the synthesis of pigments involved the following steps:

1. Characterization, Selection and Preparation of Wastes
Several metal-rich wastes are candidates as secondary raw materials for pigments formulations, once they will form the corresponding oxides after calcination in oxidizing atmosphere, normally used in the solid state reaction method of pigments production.
Amongst those we discriminate:
a) sludge generated in the wastewater treatment of the galvanizing or surface coating processes, mainly composed by metal hydroxides or other salts (with Cr, Ni, Zn, Al, Fe, etc). Normally, the sludge is constituted by colloidal (very fine) particles and contains relatively high amount of water/moisture;
b) solid wastes generated in the surface treatment of metallic pieces, such as polishing, pickling and spraying of fine powdered suspensions (painting or enamelling), constituted by metallic, ceramic or organic particles in different proportions, according to its nature. Particles are normally dry but their average size is higher than the previous family;
c) wastes and by-products from the cutting and polishing of natural or ornamental stones or generated by the corresponding mining activities. Quartz, calcite, feldspar, are common constituents. Sludges normally contain reasonably low water contents (<50%) and its removal is relatively easy to perform;
d) foundry sands that are mainly composed by quartz and organic additives.

The characterization of the wastes should be conducted on distinct batches, collected in different periods and/or locations, in order to check their temporal and spatial properties constancy and to design the best manipulation strategy (deposition, mixing, etc) to minimise possible fluctuations in their characteristics.

Accordingly, the characterization should involve:
1.1 Determination of hazardous potential The determination of toxicity degree of the waste was conducted by standard leaching tests; this information is useful to define the desirable deposition and manipulation conditions. Here, we should mention that many primary raw materials currently used to formulate the actual commercial pigments are also toxic, meaning this that no extensive further processing care requirements are needed by the use of wastes for pigments producers.
1.2 Chemical analysis This determination was conducted by X-ray fluorescence on pre-calcined wastes, just to detect the main elemental constituents in the pigment and also to predict or select its best formulation.
1.3 Determination of moisture content The moisture content (%) was always evaluated in the as-received material. If excessive, it should be removed to facilitate transportation, deposition, manipulation, and mixing steps.
1.4 Identification of crystalline phases After calcination, main crystalline phases of each material were estimated by X-ray diffraction, just to assure that main formed phases are stable (oxides) and are the expected/desirable ones.
1.5 Determination of the weight loss upon ignition (LoI %) The estimation of the loss of ignition is important to predict the remaining amount of material after calcination. It might also give an idea about the nature of volatile components in the mixture. If excessive, it might compensate the use of a pre-calcination step, in order to get a more stable material to be then used in a pigment formulation.
1.6 Determination of the particle size distribution The particle size distribution of all materials was determined by well established techniques (sedimentation or laser dispersion), and is a key parameter to obtain homogeneous mixtures and to adjust the calcination process in order to get enough reactivity. Any component should have more then 50 wt % particles between 1 and 5 μm, and to assure this the material should be properly milled or disintegrated.

2. Dosing of Wastes

According to its characteristics, namely the chemical composition, and accounting to any particular pigment formulation, each waste is conveniently weighted to be included in the batch, mixed with several other wastes or commercial raw materials.

Next, we present several examples of pigments formulations listed in table 1 that can be prepared from the mentioned wastes:
Al-rich sludges are used to produce corundum-based pigments (included in group III DCMA) or aluminate spinels (belonging to the group XIII DCMA);
Ni and Cr-rich sludges are used in formulations where those metals act as chromophores in the following structures: corundum-hematite (group III DCMA), garnet (group IV DCMA), olivine (group V DCMA), periclase (group VI DCMA), priderite (group 1×DCMA), rutile-cassiterite (group XI DCMA), sphene (group XII DCMA), and spinel (group XIII DCMA).

Fe-rich wastes might be used in the production of pigments that are based on corundum-hematite (group III DCMA), spinels (group XIII DCMA), and zircon (group XIV DCMA).

The formulations should be composed in a way that the proportions of constituents should give the desirable molar ratio of the pigment structure, in order to maximise the amount of the desirable formed phase.

To assure the desirable quality of the pigment, selected constituents (wastes or primary raw materials) should furnish all the required structural forming elements, in a balanced way that promotes the formation of compounds with the correct stoichiometry. In such way, all used elements will be involved in the development of the final desirable chemical phases, and the chromatic quality of the material is improved.

In solid solution formulations the concentration of the added active chromophore specie should not exceed the solubility limit of the forming element that it will substitute in the lattice. In this case, we must account for that substitution in the formulation, when molar proportions are defined. If the solubility limit is exceeded, the chromophore element will remain uncombined and apart the main structural phase, and chromatic properties are negatively affected. In particular, stability towards processing or using conditions (temperature and oxygen partial pressure) tends to decrease.

As an example, the formula of the sphene indicates that the molar proportion of oxides should respect CaO:SnO₂:SiO₂=1:1:1, the chromium being the chromophore specie partially substituting Sn ions in the lattice. The solubility limit for Cr corresponds to the ratio Cr/Sn=0.036. Up to this limit pigments showing several hues (light pink, red, etc) can be obtained but when that limit is exceeded crystals of free chromium oxide are visible are responsible for an undesirable green hue.

3. Mixing and Homogenisation of Components

The intimate mixture a homogenisation of components is generally conducted in ball mills and in wet conditions. It is convenient that used components show particle size as fine as possible, since mixing is facilitated. Further reactions upon calcination will be also easier and more complete, since contact area between finer particles is improved.

4. Drying

Once intimately mixed, the batch is dried (at 110° C. for 24 hours), to remove the moisture and then minimise its ignition during further calcination step. The tendency to form and decompose volatile acid compounds upon calcination is then minimised. Accordingly, the corrosion of furnace components is strongly reduced.

5. Calcination

In general, the desirable pigment structure is only obtained at relatively high temperature, and then the calcination of the dried batch is required. The need for a careful control of firing conditions, in terms of temperature and oxygen partial pressure in the atmosphere, deserves the use of proper furnaces equipped with controlling systems of gas exhausting. The thermal cycle used on each pigment is adjusted in order to develop the required phase(s), responsible for the chromatic properties.

In the actual invention, we observed that maximum calcination temperature of waste-containing formulations is lower (50 to 200° C.) than values required to calcine the corresponding waste-free pigments composed of primary conventional raw materials. This advantageous temperature decrease is certainly related with the presence of impurities in the wastes that may act as mineralising or fluxing agents upon firing of the batch.

In order to adjust the calcination temperature of each pigment, several trials should be conducted with small samples for example at intervals of 50° C. The optimal calcination temperature corresponds to the point where the major detected phase (normally by X-ray diffraction) corresponds to the desirable pigment structure and its relative amount is maximum. Below that temperature, secondary undesirable phases are still relevant, and the colour characteristics of the pigment are far from the optimal. Moreover, the presence of unreactive and decomponible compounds might originate defects in the matrix where the pigment was introduced, such as bubbles and bloatings.

In opposition, the use of excessive temperatures (above the optimal point) tends to reduce the brightness of the pigment and their chromatic components (a* and b* in the CIEL*a*b* method, further described), due to excessive formation of glassy phase and partial volatilization of certain chromophore species. The further milling or disintegration step, required to adjust the desirable particle size distribution, is a very hard task and consumes extra time and energy.

The optimal calcination temperature is then function of the pigments composition, being considered as the point that assures maximum chromatic properties.

6. Milling of the Pigment

The pigment, formed upon calcination, needs to be properly milled in order to adjust its particle size distribution, since colour characteristics are strongly affected by the average size of grains. In general, particles should have sizes between 2 and 20 μm; below 2 μm, particles tend to dissolve in the matrix where they were inserted, and colour development is far from the desirable conditions. Coarse particles (above 20 μm) are visible with the naked eye and colour homogeneity is seriously affected. The recommended mills are those that assure a narrow particle size distribution, being rapid jet mills the most common ones. Optimal milling time depends on the equipment characteristics, charge conditions (e.g. solids load), and pigment properties.

7. Washing of the Pigment

The washing step is used to remove soluble salts and is generally complemented by filtration and drying operations. Once present is reasonably amount, soluble salts might diminish the chromatic properties of the pigment and also alter the rheological behaviour of pigment suspensions. The washing in generally performed with water, under permanent stirring or in a ball mill. Then, the pigment is filtered and dried (110° C., 24 hours).

8. Characterization of the Pigment

a) identification of crystalline phases (X-Ray Diffraction), to confirm that main component is the desirable structure of the pigment; it is the main tool to adjust processing conditions, namely calcination conditions.

b) colour measurement (CIEL*a*b* method), to determine the chromatic potential of the pigment; is also a useful tool to check the effect of several processing parameters in the pigment development and than to define optimal conditions. For sake of comparison, we also determine the chromatic characteristics of similar commercial pigments or, in alternative, batches that were composed just by primary conventional raw materials.

c) leaching tests performed according to the DIN 38414-S4 standard, to check the inertization of possible hazardous species. If correctly formulated and processed, any pigment should show leaching levels of hazardous species below the legal limits.

In the actual case, pigments are mainly composed by highly stable structures, both from chemical and thermal aspects, and then they might be used to colour different matrixes, such as ceramic bodies, inks, glazes, enamels, engobes, etc., some of them further processed at high temperature, which also might reinforce the inertness degree.

In those matrixes, a good pigment should maintain their particles almost unreactive and well dispersed in order to assure a homogeneous colouration. Since they are considered technical products, we are talking about a high add-value solution for wastes recycling, assuring at the same time their complete harmfulness for the public health.

### DETAILED DESCRIPTION OF THE INVENTION

The production of inorganic pigments from industrial wastes involved the following steps:

1. Characterization, Selection, and Treatment of Wastes

According to the present invention, the wastes should be characterized and treated in the following way:
1.1 Drying of sludges Wet wastes, particularly sludges, should be previously dried (110° C. for 24 hours) prior to their insertion in any pigment formulation.
1.2 Calcination of sludges Sludges that show loss of ignition over 40% should be calcined in advance, in order to stabilize their chemical and thermal behaviour.
1.3 Analyses of the wastes After the treatment route previously described or in the as-received condition, all wastes should be characterized in terms of chemical composition (X-ray fluorescence).
1.4 Leaching tests of wastes The dangerous character of all wastes should be determined, for example by using the DIN 38414-S4 standard leaching test. In this, 50 g of a dried granular sample (<4 mm) is put in contact with 500 mL distilled water, under permanent stirring (0.5 rpm) for 24 hours. The concentration of leached species in the eluate is then determined by several accurate chemical techniques, such as the atomic absorption spectrometry.
1.5 Granulometric analysis The grain size distribution of the wastes was determined by a sedimentation method, dispersing 2 g of material in 100 mL distillate water (15 min. in ultrasounds) and by adding HCl to adjust the pH to the range between 3 and 4.
1.6 Milling of wastes If necessary, the wastes were previously disintegrated in ball mills. Then, particles were sieved at 63 μm, and just the passant material was used in pigments formulations.

2. Dosing of Wastes

According to their characteristics, measured as described in point 1, and to formulate a specific pigment, the wastes were dosing, by accurate weighting. In some cases, conventional primary raw materials were also mixed.

3. Homogeneous Mixing

The mixing of materials was performed in a ball mill, in wet conditions and normally for 1 hour.

4. Drying of the Batch

The drying was conducted at 110° C. for 24 hours in a conventional oven.

5. Calcination of the Batch

The calcination was performed in an electric kiln, at maximum temperatures ranging from 700 to 1650° C., according to the pigment structure to be obtained. A common gas kiln might also be used. Normally, the heating and cooling rate was kept constant (5° C./min.), and the soaking time at maximum temperature was 3 hours.

6. Milling of the Pigment

This operation is very important to reach the desirable grain size distribution of the pigment and was conducted in two steps: (i) pre-milling in dry conditions for 5 min., in an agate mortar; (ii) wet milling for 20 min., in a rapid or jet mill at a typical speed of 1000 rpm.

7. Washing of the Pigment

The pigment was washed in a ball mill, following consecutive cycles of 20 min. and by using the wt % ratio pigment/balls/water=1/15/30. Then the suspension was filtered and dried (110° C. for 24 hours).

8. Characterization of Pigments

The complete characterization of the pigments involves:

a) Identification of main crystalline phases (X-ray diffraction);

b) Colourimetric determinations (CIEL*a*b*);

c) Leaching tests, according to the DIN 38414-S4 standard.

9. Colouring Test of Pigments in Ceramic Bodies and Glazes

Pigments were added to glazes (5 wt %) and/or to ceramic pastes (10 wt %), in order to check their colouring power.

The preparation of samples followed the steps:

a) Dosing of the pigment and of the matrix material;

b) Wet homogeneous mixing in a ball mill for 30 min.;

c) Drying (at 110° C. for 24 hours);

d) Pressing of small cylinders (25 mm diameter);

e) Firing of samples, in an electric kiln and by using heating and cooling rate=5° C./min., and soaking time at maximum temperature of 30 min. This temperature was 1050° C. and 1200° C. for glazes and ceramic bodies, respectively.

The colour of the fired samples was determined by the CIELab method. When necessary, similar commercial pigments were also tested and evaluated, after processing in equal conditions. This helps to check the potential of new wastes-based pigments.

### EXAMPLES

### Example 1

Process for the production of distinct mixed-metal-oxide inorganic pigments from Al-anodizing or surface coating sludge+galvanizing sludge from the Cr/Ni plating process+sludge generated in the steel wiredraw process:
1. Characterization, selection, and treatment of wastes According to the actual invention, the following three different sludges were used; all they were generated in the corresponding wastewater treatment units: Al-anodizing or surface coating sludge (A-sludge); Galvanizing sludge from the Cr/Ni plating process (C-sludge); Sludge generated in the steel wiredraw process (F-sludge).

X-ray diffraction of samples, calcined at 1000° C. in an oxidizing atmosphere, reveals the dominance of the following phases:
A-sludge: Corundum, Al₂O₃;
C-sludge: NiO; NiCr₂O₄ spinel; quartz (SiO₂), and olivine (Ni₂SiO₄);
F-sludge: Hematite (Fe₂O₃), and ZnFe₂O₄ spinel.

As listed above, calcination promotes the formation of stable metal-oxide structures, adaptable to be used as secondary raw materials of pigments.

The full characterization and preparation of wastes followed the steps:
1.1 Drying of sludges Since all wastes contain relatively high moisture contents, they were dried before mixing.
1.2 Calcination of sludges Since the dried A-sludge shows a very high loss of ignition (over 40%), it was calcined (at 1300° C.) before mixing with other components.
1.3 Chemical composition of the wastes After pre-treatment steps above described, chemical composition of the sludges was determined by X-ray fluorescence (XRF), as shown in table 2. As it can be seen, A-sludge is a good source of Al/Al2O3, C-sludge might insert nickel and chromium, while F-sludge is basically composed by iron. Since C-sludge and F-sludge were used in the dried condition, the loss of ignition (LoI) in table 2 should be taken in account to correctly formulate the mixtures.
1.4 Leaching behaviour of the wastes Leaching tests were performed with dried C-sludge and F-sludge, since they contain potential hazardous elements in reasonable amounts (see table 2). A-sludge is absent of this proof, since it is classified as non-hazardous.

As already observed in table 3, only the C-sludge is considered hazardous waste, since leached amount of Ni overpasses the legal limit. As a consequence, this waste deserves a careful manipulation and processes that minimize its dispersion in the atmosphere are obviously preferred.

TABLE 2
Chemical composition of the sludges in the
as-used condition, estimated by XRF.

| | A-sludge | C-sludge | F-sludge |
|---|---|---|---|
| Components (wt %) | (1300° C.) | (1000° C.) | (1000° C.) |
| Fe₂O₃ | 0.82 | 0.53 | 64.9 |
| NiO | 0.00 | 33.2 | 0.01 |
| Cr₂O₃ | 0.51 | 14.5 | 0.07 |
| CuO | 0.00 | 3.11 | 0.01 |
| MnO | 0.00 | 0.00 | 0.41 |
| Al₂O₃ | 89.6 | 0.23 | 0.13 |
| ZnO | 0.00 | 2.13 | 2.76 |
| SiO₂ | 1.54 | 3.15 | 0.57 |
| CaO | 1.81 | 0.60 | 5.09 |
| PbO | 0.00 | 1.01 | 0.00 |
| P₂O₅ | 0.00 | 1.95 | 2.65 |
| SO₃ | 2.59 | 0.86 | 0.13 |
| CoO | 0.00 | 0.00 | 0.00 |
| Other | 3.17 | 1.67 | 3.69 |
| LoI | — | 37.1 | 19.6 |

TABLE 3
Leaching behaviour of dried C-sludge and F-sludge, performed
according to the DIN 38414-S4 standard procedure.

| Parameters | C-sludge | F-sludge | Legal limit |
|---|---|---|---|
| pH | 6.80 | 6.67 | <4 or >13 |
| Conductivity | 5.44 | 15.75 | 50-100 |
| (mS/cm) | | | |
| Cr6+ (mg/l) | 0.40 | — | 0.1-0.5 |
| Total Cr (mg/l) | 0.690 | <0.05 | 0.5-5 |
| Pb (mg/l) | <0.06 | 0.23 | 0.5-2 |
| Cu (mg/l) | 0.328 | 0.026 | 2-10 |
| Zn (mg/l) | 0.058 | 0.215 | 2-10 |
| Ni (mg/l) | 60.3 | 0.12 | 0.4-1.0 |

1.5. Grain Size Distribution

Grain size distribution of sludges C and F reveal the dominance of very fine particles (colloidal size), meaning that they do not need to be pre-milled before mixing. A-sludge was always sieved at 63 μm and just the passant fraction was used in pigment formulation.

2. Dosing of Raw Materials

Two different formulation examples will be given below Comprising wastes in their formulation.

Example of Formulation 1:

Formulation to obtain carmine pigments based on tin and chromium sphene, Ca(Sn, Cr)SiO₅, by using the C-sludge as Cr source.

Raw materials of calcium, tin, chromium and silicon are required, and we selected:
Calcite (CaCO₃) as source of calcium, having a molecular weight of 100 g/mol;
Silica sand (SiO₂) as source of silicon, having a molecular weight of 60 g/mol;
Tin oxide (SnOhd 2), 150.7 g/mol;
C-sludge, since each dried portion of 100 g will introduce 14.5 g Cr₂O₃, (=0.095 mol) in the mixture.

In order to get the maximum Cr content in the desired structure (Cr=0.036, sub-stituting Sn) the following ratio should be used: SnO₂:Cr₂O₃:SiO₂=1:(1-0.036):(0.036/2):1.

To get 1 mol de CaO we need to add 100.00 g of calcite.

To obtain 0.964 mol SnO₂, we should use 145.27 g tin oxide.

To get 0.018 moles Cr₂O₃ we need to use 37.76 g C-sludge.

Finally, to obtain 1 mol SiO₂, we need to add 60.00 g of pure silica sand.

Recalculating the formulation as weight % we get:

29.15% calcite+42.35% SnO₂+11.00% C-sludge+17.50 silica sand.

This formulation corresponds to the pigment showing the strongest saturated hue. Different hues might be achieved by changing the mentioned proportions and by keeping Cr ratio below 0.036.

### Example of Formulation 2:

Formulation of a black pigment based on the structure of Ni(Fe, Cr)₂O₄ spinel, only by the use of wastes.

This is a structural pigment having the formula Ni(Fe, Cr)₂O₄, and is obtained by fixing the molar ratio NiO:(Fe₂O₃+Cr₂O₃)=1:1. It can be formulated mainly by means of combining two of the mentioned wastes:

C-sludge, as source of Ni and Cr; F-sludge to introduce Fe.

Each portion of 100 g of dried C-sludge introduces 14.95 g Cr₂O₃, (=0.095 mol)+33.17 g NiO (=0.444 mol).

Each 100 g of dried F-sludge will give 64.91 g Fe₂O₃ (=0.406 mol).

This means that 1 mol NiO is obtained when 225.23 g C-sludge is used, and this amount also introduces 0.215 mol Cr₂O₃.

We need (1-0.215=0.785) mol Fe₂O₃, given by 193.35 g of dried F-sludge.

Recalculating in terms of weight % we get: 53.81% C-sludge+46.19% F-sludge.

Application Tests of Pigments in Ceramic Products

The pigments were added to common commercial products, to evaluate the colour development: (i) a transparent and shining lead-free glaze, hereby referred as VTB, to be fired at 1050° C.; (ii) an opaque and shining glaze, referred as VOB, also to be fired at 1050° C.; (iii) a transparent and shining glaze, referred as VTBA, to be fired at 1200° C.; (iv) and a ‘porcellanato’ ceramic body, referred as CB, also to be fired at 1200° C.

All the processing steps were conducted as previously described.

Next, we will detail the formulation and colour characteristics of distinct pigments, obtained by the process hereby described. We give the admissible composition intervals for the components, and the calcination temperature. The colour properties of glazes and ceramic bodies where they were applied are also given.

Pigments Based on the Corundum Structure (Reference 03 DCMA)

These are solid solution pigments, based on the corundum (Al₂O₃) structure, in which some chromophore trivalent species (Cr³⁺, Fe³⁺, and Mn³⁺) might partially substitute Al₃₊ ions. Tested formulations involved the use of Fe₂O₃, Cr₂O₃, or MnO₂ (5 to 20 wt %), while A-sludge was the main component and source of alumina. We might also enlarge the relative proportion of chromophore species up to the solubility limit, and then improve or change the chromatic properties of the resulting pigments. For example, by playing with Cr/Al ratio we might produce green or pink pigments.

TABLE 4
Corundum based pigment formulations and corresponding calcination temperatures.

| | Calcination Temp. | Formulations (wt %) | | | | |
|---|---|---|---|---|---|---|
| Reference | [° C.] | A-sludge | C-sludge | Cr₂O₃ | MnO₂ | Fe₂O₃ |
| 03-Cr-A | 1450-1650 | ≧80.0 | 0.0 | ≦20.0 | 0.0 | 0.0 |
| 03-C-AC | 950-1250 | ≦80.0 | ≧20.0 | 0.0 | 0.0 | 0.0 |
| 03-Mn-A | 1450-1650 | ≧80.0 | 0.0 | 0.0 | ≦20.0 | 0.0 |
| 03-Fe-A | 1450-1650 | ≧80.0 | 0.0 | 0.0 | 0.0 | ≦20.0 |

[Notation = structure (DCMA) - chemical symbol of chromophore - sludges. This notation was also used in the coming tables].

TABLE 5
L*a*b* values for the sintered pigments and the applications (VTB
and VOB glazes + 4 wt-% of pigment). [L* = brightness;
a* = red(+)/green(−); b* = blue(+)/yellow(−)]

| | | Colour coordinates | | | | | | | | |
|---|---|---|---|---|---|---|---|---|---|---|
| | Temp. | Pigment | | | VTB | | | VOB | | |
| Ref. | [° C.] | L* | a* | b* | L* | a* | b* | L* | a* | b |
| 03-Cr-A | 1650 | 89.8 | 9.4 | −1.2 | 60.2 | 12.4 | 13.0 | 77.3 | 6.8 | 4.7 |
| 03-Cr-AC | 1100 | 27.2 | −1.8 | 5.0 | 29.1 | −1.5 | 4.7 | 56.0 | −0.8 | 7.4 |
| 03-Mn-A | 1650 | 76.0 | 6.8 | 8.5 | 68.4 | 12.9 | 15.7 | 83.2 | 5.0 | 3.4 |
| 03-Fe-A | 1650 | 76.6 | 7.1 | 15.9 | 73.0 | 6.2 | 39.9 | 89.2 | 0.3 | 11.6 |

Hematite-Based Pigments (Ref. 03)

This is also a structural pigment based on the hematite phase, having the general formula A₂O₃, in which A represents Cr or Fe trivalent ions.

This type of pigments might be formulated by the exclusive use of wastes that are composed by chromium and iron oxides. As an example, we prepared the 03-Fe-F pigment just from the F-sludge, by calcining the material at temperatures ranging from 850 to 1150° C. By XRD, we proved that obtained material is composed by hematite.

TABLE 6
L*a*b* values for the sintered pigments and the applications (VTB
and VOB glazes + 5 wt-% of pigment).

| | | Colour coordinates | | | | | | | | |
|---|---|---|---|---|---|---|---|---|---|---|
| | Temp. | Pigment | | | V TB | | | V OB | | |
| Ref. | [° C.] | L* | a* | B* | L* | a* | b* | L* | A* | b* |
| 03-Fe—F | 950 | 27.3 | 0.4 | −1.5 | 1. | 1. | 1. | 71.7 | 1.8 | 20.4 |

Olivine-Based Pigments (Ref. 05)

This structural pigment is based on the olivine phase (A₂SiO₄), being A the chromophore specie (Ni²⁺ or Co²⁺).

TABLE 7
Tested compositions to get olivine-based pigments
and used calcination temperatures.

| | |
|---|---|
| Calcination Temp. | Formulations (wt %) |

| Ref. | [° C.] | C-sludge | SiO₂ |
|---|---|---|---|
| 05-Ni—C | 950-1250 | 75.0-95.0 | 5.0-25.0 |

TABLE 8
L*a*b* values for the sintered pigments and the applications (VTB
and VOB glazes + 5 wt-% of pigment).

| | | Colour coordinates | | | | | | | | |
|---|---|---|---|---|---|---|---|---|---|---|
| | | Pigment | | | V TB | | | V OB | | |
| Ref. | Temp. [° C.] | L* | a* | b* | L* | a* | B* | L* | A* | b* |
| 05-Ni—C | 1050 | 47.4 | −11.5 | 21.2 | 40.5 | −11.1 | 14.4 | 61.9 | −9.2 | 10.4 |

Cassiterite Based Pigments (Ref. 11)

This is a solid solution pigment that is based on the cassiterite structure (SnO₂) and in which the chromophore specie partially replaces Se⁴⁺ ions. In this example, we test the use of chromium, introduced by the C-sludge. By playing with its relative amount, up to the solubility limit, we can obtain distinct violet hues.

TABLE 9
Tested compositions to get Cr-cassiterite
pigments and used calcination temperatures.

| | |
|---|---|
| Calcination Temp. | Formulations (wt %) |

| Ref. | [° C.] | C-sludge | SnO₂ |
|---|---|---|---|
| 11-Cr-C | 1350-1550 | ≦25.0 | ≧75.0 |

TABLE 10
L*a*b* values for the sintered pigments and the applications (VTB
and VOB glazes + 5 wt-% of pigment).

| | | Colour coordinates | | | | | | | | |
|---|---|---|---|---|---|---|---|---|---|---|
| | | Pigment | | | VTB | | | VOB | | |
| Ref. | Temp. [° C.] | L* | a* | b* | L* | a* | b* | L* | a* | b* |
| 11-Cr—C | 1450 | 34.5 | 7.5 | −6.0 | 44.5 | 4.1 | −5.0 | 72.6 | 2.8 | −1.1 |

Malayaite-Based Pigments (Ref. 12)

This is a solid solution pigment based on the sphene structure, also named malayaite and having the general formula CaSnSiO₅. In this structure, the chromophore specie might partially replace sn⁴⁺ ions. In this example we mention the use of chromium, inserted by the C-sludge, in relative amounts up to the solubility limit to get distinct hues changing from the light pink to the dark red (red wine).

TABLE 11
Tested compositions to get sphene/malayaite (>>98 wt %) pigments
and used calcination temperatures.

| | Calcination | Formulations (wt %) | | | |
|---|---|---|---|---|---|
| Ref. | Temp. [° C.] | C-sludge | CaCO₃ | SiO₂ | SnO₂ |
| 12-Cr—C | 1250-1450 | ≦11.0 | 29.1-32.0 | 17.5-19.5 | 42.4-48.5 |

TABLE 12
L*a*b* values for the sintered pigments and the applications (VTB
and VOB glazes + 5 wt-% of pigment).

| | | Colour coordinates | | | | | | | | |
|---|---|---|---|---|---|---|---|---|---|---|
| | | Pigment | | | VTB | | | VOB | | |
| Ref. | Temp. [° C.] | L* | a* | B* | L* | A* | B* | L* | a* | b* |
| 12-Cr—C | 1350 | 39.6 | 22.8 | 4.1 | 41.8 | 19.2 | 4.8 | 69.9 | 12.1 | 0.8 |

TABLE 13
L*a*b* values for the sintered pigments and the applications (VTBA
glaze + 5 wt-% of pigment and PCG + 10 wt-% of pigment).

| | | Colour coordinates | | | | | |
|---|---|---|---|---|---|---|---|
| | Temp. | VTBA | | | PCG | | |
| Ref. | [° C.] | L* | a* | b* | L* | a* | b* |
| 12-Cr—C | 1350° C. | 34.5 | 14.5 | 2.8 | 46.8 | 5.2 | 6.9 |

Pigments Based on the Spinel Structure (Ref. 13)

This family of structural pigments in based on the spinel structure (AB₂O₄), where A represents divalent ions (Co²⁺, Zn²⁺, Ti²⁺, Fe²⁺, Ni²⁺, Cu²⁺, Mn²⁺, Mg²⁺, and Sn²⁺) and B represents trivalent species (Al³⁺, Co³⁺, Cr³⁺, Fe³⁺, and Mn³⁺). Since those species might be chromophore, distinct colour might by obtained depending on their nature and pro-portions, on their location in the structure and on processing conditions (temperature and oxygen partial pressure of the atmosphere).

The measurement of colour characteristics of applications, according to the CIELab method, assures their potential as inorganic pigments. Moreover, they are thermally and chemically stable, within reasonable processing limits.

According to the actual invention, several formulations have being produced and tested, based on structures such as hematite, olivine, cassiterite, sphene, and spinel. Some examples are given in tables 14-16.

TABLE 14
Tested compositions to spinel-based pigments and used
calcination temperatures.

| | Calcination | Formulations (wt %) | | | |
|---|---|---|---|---|---|
| Ref. | Temp. [° C.] | A-sludge | C-sludge | F-sludge | ZnO |
| 13-Cr, | 950-1250 | 5.0-40.0 | 10.0-50.0 | 10.0-50.0 | 5.0-40.0 |
| Fe-ACF | | | | | |
| 13-Cr, | 700-1100 | 0.0 | 40.0-75.0 | 25.0-60.0 | 0.0 |
| Fe—CF | | | | | |

TABLE 15
L*a*b* values for the sintered pigments and the applications (VTB
and VOB glazes + 5 wt-% of pigment).

| | | Colour coordinates | | | | | | | | |
|---|---|---|---|---|---|---|---|---|---|---|
| | Temp. | Pigment | | | VTB | | | VOB | | |
| Ref. | [° C.] | L* | a* | b* | L* | a* | b* | L* | a* | b* |
| 13-Cr, | 1150 | 25.0 | 8.0 | 8.9 | 30.5 | 5.0 | 7.9 | 57.8 | 10.6 | 27.8 |
| Fe-ACF | | | | | | | | | | |
| 13-Cr, | 700 | 20.5 | 9.8 | 9.4 | 23.6 | 2.4 | 2.6 | 41.0 | 6.2 | 7.4 |
| Fe-CF | | | | | | | | | | |
| 13-Cr, | 900 | 19.6 | −0.9 | −1.2 | 26.7 | −1.2 | 1.6 | 54.3 | −1.7 | −0.3 |
| Fe-CF | | | | | | | | | | |

TABLE 16
L*a*b* values for the sintered pigments and the applications (VTBA
glaze + 5 wt-% of pigment and PCG + 10 wt-% of pigment).

| | | Colour coordinates | | | | | |
|---|---|---|---|---|---|---|---|
| | Temp. | VTBA | | | PCG | | |
| Ref. | [° C.] | L* | a* | b* | L* | a* | b* |
| 13-Cr, Fe—CF | 900 | 25.3 | −1.5 | −1.4 | 27.5 | 0.5 | 0.5 |

Example of Inertization of Hazardous Species Assured by Processing the Pigment.

To prove the inertization potential of hazardous species assured by the processing of pigments, we selected one composition that is exclusively formulated from industrial wastes (50 wt % C-sludge+50 wt % F-sludge).

Table 17 clearly shows that leaching levels of hazardous species (Ni, Cr, etc) from the 13-Cr, Fe-CF black pigment, calcined at 900° C., are well below the limits that define harmful effects for the public health.

We should also remind that C-sludge, now used to compose half of the pigment formulation, is classed as hazardous waste (see table 3), mainly due to high leaching levels of Ni. This clearly means, that the use of a correct and well controlled process of pigments production also assures the inertization of potential hazardous species, mainly due reactions promoted at high temperatures.

TABLE 17
Leaching behaviour of the 13-Cr, Fe-CF pigment, calcined at
900° C., performed according to the DIN 38414-S4 standard.

| | Pigment | |
|---|---|---|
| | 13-Cr, Fe-CF | |
| Parameters | Calcined at 900° C. | Limit |
| pH | 6.57 | <4 or >13 |
| Conductivity (mS/cm) | 0.06 | 50-100 |
| Cr⁶⁺(mg/l) | — | 0.1-0.5 |
| Total Cr (mg/l) | <0.05 | 0.5-5 |
| Pb (mg/l) | <0.06 | 0.5-2 |
| Cu (mg/l) | <0.025 | 2-10 |
| Zn (mg/l) | 0.069 | 2-10 |
| Ni (mg/l) | 0.07 | 0.4-1.0 |

1. A process for the production of mixed-metal-oxide inorganic pigments from industrial wastes, utilizing industrial wastes as raw materials, comprising:
a) selection and dosage of the raw materials;
b) homogenizing and mixture with other components;
c) drying;
d) calcination; and e) finally milling, washing, filtering and drying to obtain the pigment.

2. The process for the production of mixed-metal-oxide inorganic pigments, according to claim 1, wherein the industrial wastes used as raw materials being rich in metallic elements that will generate, after proper calcination used to produce the pigments, metal-oxide structures easily identified by X-ray diffraction.

3. The process for the production of mixed-metal-oxide inorganic pigments, according to claim 1, wherein the industrial wastes, used as raw materials, are rich in metallic elements, preferably but not exclusively wastes from the metallurgic or metal shaping sectors, including those from mining extraction activities, foundry of metallic pieces, sludges from wastewater treatment of galvanizing or surface coating processes, pickling material used in the shipbuilding industry, and fines or sludge generated in the cutting and polishing operations of natural and ornamental rocks, etc.

4. The process for the production of mixed-metal-oxide inorganic pigments, according to claim 1, wherein other materials, such as oxides or salts of the required metals, are combined with the selected and characterized industrial wastes.

5. The process for the production of mixed- metal-oxide inorganic pigments, according to claim 1, wherein the calcination of the mixing takes place in a kiln equipped with gas exhaustion, or in a similar furnace, at a lower temperature (−200<0>C), than that required to process similar waste-free pigments.

6. Use of the process for the production of mixed-metal-oxideinorganic pigments, according to claim 1, wherein it is applicable to the production of mixed-metal-oxide inorganic pigments from industrial wastes with high thermal and chemical stability, being suitable to incorporated in different materials such as inks, glazes, enamels, engobes, and ceramic pastes or bodies.
